(19) United States
(12) Patent Application Publication
(10) Pub. No.: US 2025/0337633 A1
(43) Pub. Date: Oct. 30, 2025

(54) AUTOMATIC DRILL-DOWN AND ANALYSIS OF ERROR SCENARIOS DURING NETWORK OPERATIONS

(71) Applicant: Dell Products L.P., Round Rock, TX (US)

(72) Inventors: Ritika Vaishya, Pune (IN); Jagannathdas Rath, Bengaluru (IN)

(21) Appl. No.: 18/646,307

(22) Filed: Apr. 25, 2024

(51) Int. Cl. H04L 41/0654

(52) U.S. Cl. CPC H04L 41/0654

(57) ABSTRACT

Techniques described herein relate to a method for managing network request failures. The method includes identifying a network request failure making a determination that a retry limit is exceeded; in response to the determination: pausing other retry methods and network requests; after pausing: triggering network tracing for network requests; performing a retry of the failed network request with the network tracing; after performing the retry: resuming other network requests and retry methods; filtering tracing information obtained from the network tracing to obtain packets associated with the failed network request; identifying a retry stream identifier associated with retry stream responses of the network request retry; performing extraction of the packets and the retry stream responses associated with the stream identifier to obtain an error narrative; storing the error narrative in a log repository; and initiating the performance of network request failure remediation using the error narrative.

### BACKGROUND

Computing devices may provide services for users. To provide the services, the computing device may communication with other computing devices. The communications between devices may fail. The failure of the communications between computing devices may result in the degradation of services provided to users. Users may desire remediate the communication failures. The cause of the communication failures may be required to remediate the communication failures.

### SUMMARY

In general, in one aspect, the embodiments disclosed herein relate to a method performed to network request failures. The method includes identifying, by a drill-down manager of a client, a network request failure, wherein the network request is sent by the client to a target through a network; in response to the identification: making a determination that a retry limit is exceeded; in response to the determination: pausing other retry methods and network requests; after pausing: triggering network tracing for network requests; performing a retry of the failed network request with the network tracing; after performing the retry: resuming other network requests and retry methods; filtering tracing information obtained from the network tracing to obtain packets associated with the failed network request; identifying a retry stream identifier associated with retry stream responses of the network request retry; performing extraction of the packets and the retry stream responses associated with the stream identifier to obtain an error narrative; storing the error narrative in a log repository; and initiating network request failure remediation using the error narrative.

In general, in one aspect, the embodiments described herein relate to a non-transitory computer readable medium which includes computer readable program code, which when executed by a computer processor enables the computer processor to perform a method for managing network request failures. The method includes identifying, by a drill-down manager of a client, a network request failure, wherein the network request is sent by the client to a target through a network; in response to the identification: making a determination that a retry limit is exceeded; in response to the determination: pausing other retry methods and network requests; after pausing: triggering network tracing for network requests; performing a retry of the failed network request with the network tracing; after performing the retry: resuming other network requests and retry methods; filtering tracing information obtained from the network tracing to obtain packets associated with the failed network request; identifying a retry stream identifier associated with retry stream responses of the network request retry; performing extraction of the packets and the retry stream responses associated with the stream identifier to obtain an error narrative; storing the error narrative in a log repository; and initiating network request failure remediation using the error narrative.

In general, in one aspect, embodiments described herein relate to a system for validating a recovery log. The system includes a target and a client that includes memory and a processor that is configured to perform a method. The method includes identifying, by a drill-down manager of a client, a network request failure, wherein the network request is sent by the client to a target through a network; in response to the identification: making a determination that a retry limit is exceeded; in response to the determination: pausing other retry methods and network requests; after pausing: triggering network tracing for network requests; performing a retry of the failed network request with the network tracing; after performing the retry: resuming other network requests and retry methods; filtering tracing information obtained from the network tracing to obtain packets associated with the failed network request; identifying a retry stream identifier associated with retry stream responses of the network request retry; performing extraction of the packets and the retry stream responses associated with the stream identifier to obtain an error narrative; storing the error narrative in a log repository; and initiating network request failure remediation using the error narrative.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1A shows a diagram of a system in accordance with one or more embodiments disclosed herein.

FIG. 1B shows a diagram of a client in accordance with one or more embodiments disclosed herein.

FIG. 2 shows a flowchart of a method for managing network operation failures in accordance with one or more embodiments disclosed herein.

FIGS. 3A-3D show diagrams of an example in accordance with one or more embodiments disclosed herein.

FIG. 4 shows a diagram of a computing device in accordance with one or more embodiments disclosed herein.

### DETAILED DESCRIPTION

Specific embodiments will now be described with reference to the accompanying figures. In the following description, numerous details are set forth as examples of the embodiments disclosed herein. It will be understood by those skilled in the art that one or more embodiments disclosed herein may be practiced without these specific details and that numerous variations or modifications may be possible without departing from the scope of the embodiments disclosed herein. Certain details known to those of ordinary skill in the art are omitted to avoid obscuring the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention relate to methods, systems, and non-transitory computer readable mediums for managing network request failures.

While performing any network operations there may be error or failure scenarios at the server side resulting in failure of the operation. Many times, the failures respond back with proper error messages and error codes and it's much easier to identify the root cause of the issues just by seeing them. Also, there may be intermittent failures, which succeed on subsequent retries. But, lot of times, the failures and error messages are very cryptic in nature or very generic, depending on how the service side is implemented. For ex., some common errors in network operations are due to issues like: (i) misconfigurations like less privileges for the user/account (ii) non-reachability of the cloud server from the client side (firewalls, bad gateways, bad proxy servers etc.), (iii) internal server errors (e.g., internal to the cloud storage software stack), (iv) signing signature mismatches, and (v) no space for new data in the cloud storage. These issues are not intermittent and may need admins to fix configuration/privileges in the server end (ex. cloud provider account/configuration).

Client-side code in products generally have retry mechanisms for some of the operations (e.g., one or more retries with a pause) to retry the failed requests with the hope that subsequent ones would pass. That works for intermittent issues, but fails for issues like above, which needs manual interventions and fixing of configurations or other areas. For such issues, there would be multiple requests for the same operation, and all would eventually fail. Products may retry operations with debug log mode enabled to get more detailed error messaging. But, these retries and logging are still in the client side only.

In the field, when such failures are seen, defects and escalations are immediately filed by customer with the product vendor, in spite of the issue being a mis-configuration or unreachability that needs to be fixed by customer teams or in customer premises. Product vendor's support analyzes the defects and even involves engineering teams to attempt to identify the root cause of the issue. The conclusion from engineering mostly turns out that things need to be fixed at the customer infrastructure or customer's cloud account. An example flow may include: (i) support bundles are collected and logs are analyzed, (ii) support is asked to trigger packet tracing and get back with the capture logs, which are then analyzed by engineering, (iii) many times, even a customer is asked to engage the cloud provider's support as well to verify things or fetch more internal logs, etc. So, a lot of time is spent in various levels, spanning across a few or even many days, only to conclude later that there is no issue from product side and things needs to be analyzed further or fixed in customer side and/or their cloud account configuration. This turnaround time could have been avoided or reduced to a great extent with a more detailed error analysis in the first level itself. Embodiments disclosed herein may be applicable for any Simple Storage Service (S3), Hypertext Transfer Protocol (HTTP), and/or Hypertext Transfer Protocol Secure (HTTPS) communication between a client and a server.

Embodiments disclosed herein relate to systems, methods, and/or non-transitory computer readable mediums to automatically drill down and perform additional auto analysis whenever error scenarios are seen in the system (e.g., errors related to HTTP 3xx, 4xx, 5xx, etc.) in order to provide as much details as possible for the error cases.

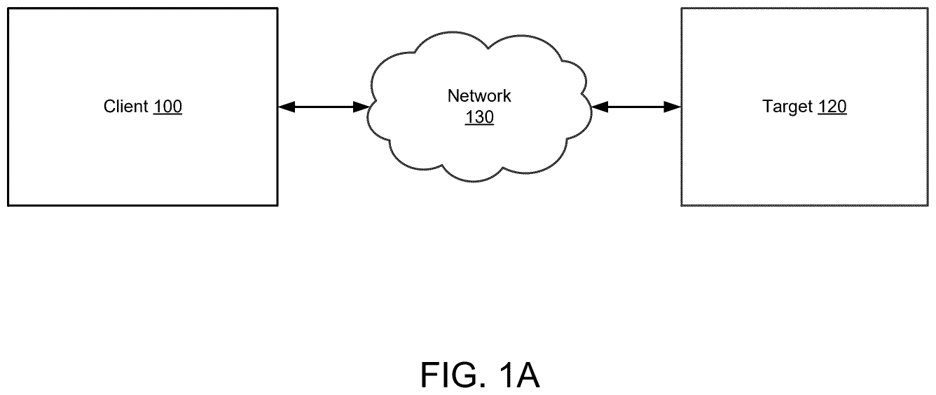

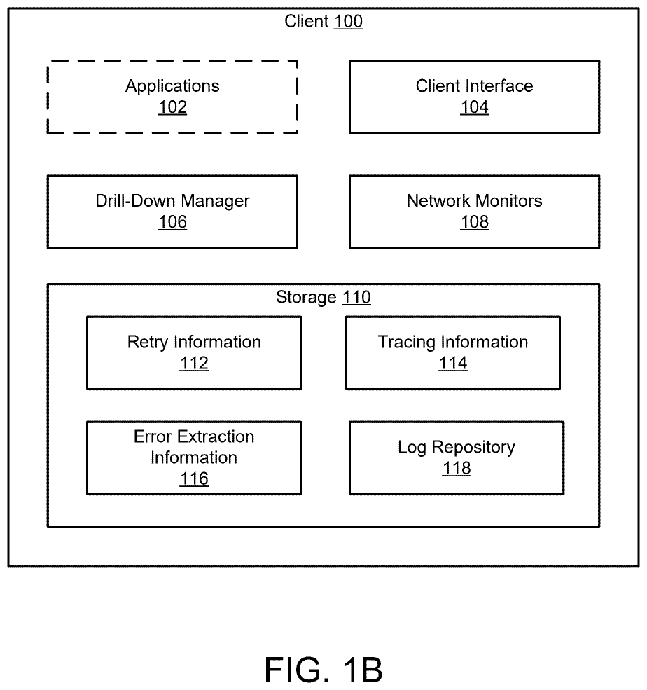

FIG. 1A shows a diagram a system in accordance with one or more embodiments disclosed herein. The system may include a client (100), a target (120), and a network (130). The components of the system illustrated in FIG. 1A may be operatively connected to each other and/or operatively connected to other entities (not shown) via any combination of wired (e.g., Ethernet) and/or wireless networks (e.g., local area network, wide area network, Internet, etc.) without departing from embodiments disclosed herein. Each component of the system illustrated in FIG. 1A is discussed below.

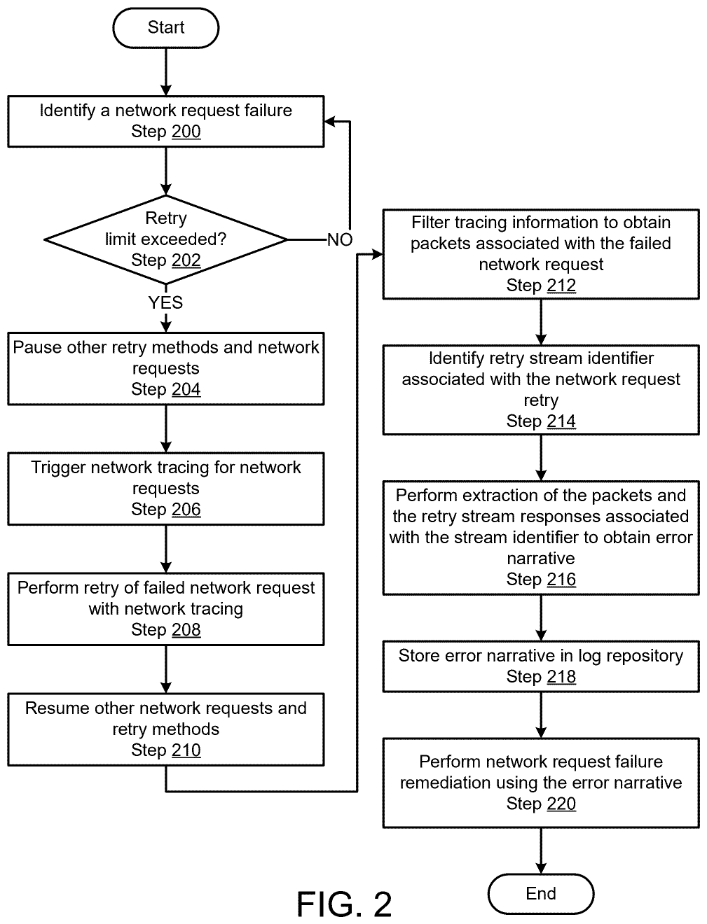

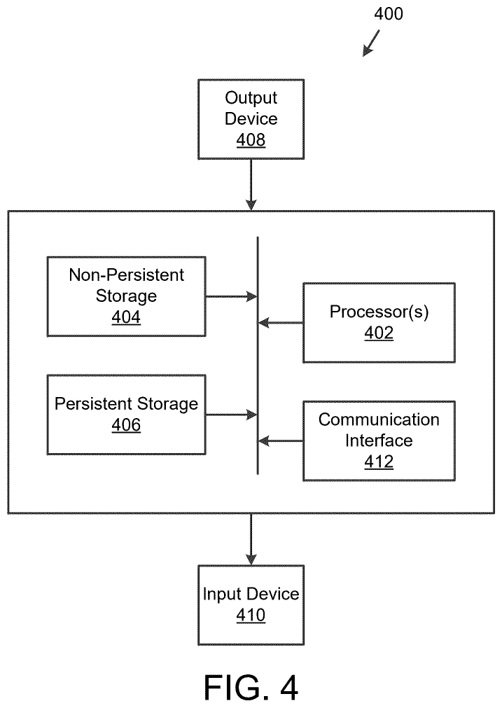

In one or more embodiments, the client (100) may be implemented using one or more computing devices. A computing device may be, for example, a mobile phone, tablet computer, laptop computer, desktop computer, server, distributed computing system, or a cloud resource. The computing device may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions of the clients (100) described herein and/or all, or a portion, of the methods illustrated in FIG. 2. The clients (100) may be implemented using other types of computing devices without departing from the embodiments disclosed herein. For additional details regarding computing devices, refer to FIG. 4.

The client (100) may be implemented using logical devices without departing from the embodiments disclosed herein. For example, the client (100) may include virtual machines that utilize computing resources of any number of physical computing devices to provide the functionality of the client (100). The client (100) may be implemented using other types of logical devices without departing from the embodiments disclosed herein.

In one or more embodiments, the client (100) may include the functionality to, or otherwise be programmed or configured to, perform computer implemented services for users of the client (100). The computer implemented services may include electronic mail communication services, database services, calendar services, inferencing services, and/or word processing services. The computer implemented services may include other and/or additional types of services without departing from embodiments disclosed herein. The client (100) may also include the functionality to obtain other computer implemented services from the target (120). The target (120) may include the functionality to provide any computer implemented services that a client (100) or a user of the client (100) may require. The target (120) may include additional computing resources (e.g., computing processors, memory, storage, data, etc.) and may be able to provide more quantities of computer implemented services and/or more complex computer implemented services (e.g., machine learning model training, long term backup storage, data redundancy, etc.). The computer implemented services obtained by the client (100) from the target (120) may include the aforementioned computer implemented services and/or any other types of computer implemented services without departing from embodiments disclosed herein. The client (100) may include the functionality to perform all, or a portion of, the methods discussed in FIG. 2. The client (100) may include other and/or additional functionalities without departing from embodiments disclosed herein. For additional information regarding the client (100), refer to FIG. 1B.

In one or more embodiments, the target (120) may be implemented using one or more computing devices. A computing device may be, for example, mobile phones, tablet computers, laptop computers, desktop computers, servers, or cloud resources. The computing device may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions described herein and/or all, or a portion, of the methods illustrated in FIG. 2. The target (120) may be implemented using other types of computing devices without departing from embodiments disclosed herein. For additional details regarding computing devices, refer to FIG. 4.

The target (120) may be implemented using logical devices without departing from the embodiments disclosed herein. For example, the target (120) may include virtual machines that utilize computing resources of any number of physical computing devices to provide the functionality of the target (120). The target (120) may be implemented using other types of logical devices without departing from the embodiments disclosed herein.

In one or more embodiments, the target (120) may include the functionality to perform and provide the computer implemented services for the users of the client (100). As such, the target (120) may include the functionality to perform the following services: electronic mail communication services, database services, calendar services, inferencing services, word processing services, machine learning model training services, long term backup storage services, data redundancy services, data deduplication services, data compression services, etc. The target (120) may include the functionality to perform other and/or additional services without departing from embodiments disclosed herein. In one or more embodiments, to perform the computer implemented services the target (120) may send/obtain requests and information to/from the client (100) through communications via network operations.

As used herein, “communication” may refer to simple data passing, or may refer to two or more components coordinating a job. As used herein, the term “data” is intended to be broad in scope. In this manner, that term embraces, for example (but not limited to): data segments that are produced by data stream segmentation processes, data chunks, data blocks, atomic data, emails, objects of any type, files of any type (e.g., media files, spreadsheet files, database files, etc.), contacts, directories, sub-directories, volumes, etc.

In one or more embodiments, the network (130) may be implemented using one or more computing devices. A computing device may be, for example, a mobile phone, tablet computer, laptop computer, desktop computer, server, distributed computing system, or a cloud resource. The computing device may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions of the network (130) described herein and/or all, or a portion, of the methods illustrated in FIG. 2. The network (130) may be implemented using other types of computing devices without departing from the embodiments disclosed herein. For additional details regarding computing devices, refer to FIG. 4.

The network (130) may be implemented using logical devices without departing from the embodiments disclosed herein. For example, the network (130) may include virtual machines that utilize computing resources of any number of physical computing devices to provide the functionality of the network (130). The network (130) may be implemented using other types of logical devices without departing from the embodiments disclosed herein.

In one or more embodiments, the network (130) may represent a (decentralized or distributed) computing network and/or fabric configured for computing resource and/or messages exchange among registered computing devices (e.g., the client (100) and the target (120)). As discussed above, components of the system may operatively connect to one another through the network (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network (130) may be implemented using any combination of wired and/or wireless network topologies, and the network may be operably connected to the Internet or other networks. Further, the network (130) may enable interactions between, for example, the client (100) and the target (120) through any number and type of wired and/or wireless network protocols (e.g., TCP, UDP, IPv4, etc.).

The network (130) may encompass various interconnected, network-enabled subcomponents (not shown) (e.g., switches, routers, gateways, cables etc.) that may facilitate communications between the components of the system. In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network (130) and its subcomponents may be implemented using hardware, software, or any combination thereof.

In one or more embodiments, before communicating data over the network (130), the data may first be broken into smaller batches (e.g., data packets) so that larger size data can be communicated efficiently. For this reason, the network-enabled subcomponents may break data into data packets. The network-enabled subcomponents may then route each data packet in the network (130) to distribute network traffic uniformly.

In one or more embodiments, the network-enabled subcomponents may decide how real-time (e.g., on the order of ms or less) network traffic and non-real-time network traffic should be managed in the network (130). In one or more embodiments, the real-time network traffic may be high-priority (e.g., urgent, immediate, etc.) network traffic. For this reason, data packets of the real-time network traffic may need to be prioritized in the network (130). The real-time network traffic may include data packets related to, for example (but not limited to): videoconferencing, web browsing, voice over Internet Protocol (VoIP), etc.

Although the system of FIG. 1A is shown as having a certain number of components (e.g., 100, 120, 130), in other embodiments disclosed herein, the system may have more or fewer components. For example, there may be multiple clients and multiple targets. As another example, the functionality of each component described above may be split across components or combined into a single component. Further still, each component may be utilized multiple times to carry out an iterative operation.

FIG. 1B shows a diagram of a client in accordance with one or more embodiments disclosed herein. The client (100) may be an embodiment of the client (100, FIG. 1A) discussed above. As discussed above, the client (100) may include the functionality to perform computer implemented services for a user and obtain computer implemented services from the target (120, FIG. 1A). To perform the aforementioned services, the client (100) may include applications (102), a client interface (104), a drill-down manager (106), network monitors (108), and storage (110). The client (100) may include other, additional, and/or fewer components without departing from embodiments disclosed herein. Each of the aforementioned components of the client (100) are discussed below.

In one or more embodiments disclosed herein, the applications (102) are implemented as computer instructions, e.g., computer code, stored on a storage (e.g., 110) that when executed by a processor of the client (100) causes the client (100) to provide the functionality of the applications (102) described throughout this Detailed Description. The applications (102) may include the functionality to perform or otherwise provide the computer implemented services to users of the client (100). The applications (102) may include other and/or additional functionalities without departing from embodiments disclosed herein. Each application may be a portion of the computer instructions discussed above, which when executed by a processor of the client (100), cause the client (100) to perform a portion of the computer implemented services performed by the client (100). For example, a database application may perform database services, a word processing application may perform word processing services, and an electronic mail communication application may perform electronic mail communication services, etc.

In one or more embodiments disclosed herein, the client interface (104) may represent an application programming interface (API) (e.g., a communication channel, an entry point to the client, etc.) for the client (100). To that extent, the client interface (104) may employ a set of subroutine definitions, protocols, and/or hardware/software components for enabling communications between the client (100) and external entities e.g., the target (120). One of ordinary skill will appreciate that the client interface (104) may perform other functionalities without departing from the scope of the invention. The client interface (104) may be implemented using hardware, software, or any combination thereof.

In one or more embodiments disclosed herein, the drill-down manager (106) may be implemented as a physical device. The physical device may include circuitry. The physical device may be, for example, a field-programmable gate array, application specific integrated circuit, programmable processor, microcontroller, digital signal processor, or other hardware processor. The physical device may be configured to provide the functionality of the drill-down manager (106) described throughout this Detailed Description.

In one or more embodiments disclosed herein, the drill-down manager (106) may be implemented as computer instructions, e.g., computer code, stored on a storage (e.g., 110) that when executed by a processor of the client (100) causes the client (100) to provide the functionality of the drill-down manager (106) described throughout this Detailed Description.

In one or more embodiments, the drill-down manager (106) may include the functionality to perform network operation failure management services. The network operation failure management services performed by the drill-down manager (106) may include automatically performing drill-down analysis of network request failures. The drill-down analysis may include (i) identifying network operation failures between the client (100) and the target (120, FIG. 1A), (ii) initiating automatic drill-down analysis based on the network operation failures, (iii) pausing and resuming other network operations based on the automatic drill-down analysis, (iv) extracting error information from tracing information, etc. The drill-down manager (106) may include the functionality to perform all, or a portion, of the method discussed in FIG. 2. The drill-down manager (106) may include other and/or additional functionalities without departing from embodiments disclosed herein. For additional information regarding the functionality of the drill-down manager (106), refer to FIG. 2.

In one or more embodiments disclosed herein, the network monitors (108) may be implemented as one or more physical devices. A physical device may include circuitry. The physical device may be, for example, a field-programmable gate array, application specific integrated circuit, programmable processor, microcontroller, digital signal processor, or other hardware processor. The physical device may be configured to provide the functionality of the network monitors (108) described throughout this Detailed Description.

In one or more embodiments disclosed herein, the network monitors (108) are implemented as computer instructions, e.g., computer code, stored on a storage (e.g., 110) that when executed by a processor of the client (100) causes the client (100) to provide the functionality of the network monitors (108) described throughout this Detailed Description.

In one or more embodiments disclosed herein, the network monitors (108) may include the functionality to perform network tracing services for the client (100). Accordingly, the network monitors (108) may include the functionality to (i) obtain network packets associated with network operation failures, (ii) obtain network operation failure responses associated with network operation failures, (iii) generating tracing information associated with network operation failures, etc. The network monitors (108) may include the functionality to perform all, or a portion of, the method of FIG. 2. The network monitors (108) may include other and/or additional functionalities without departing from embodiments disclosed herein. The network monitors (108) may be implemented using services such as tcpdump, wireshark, tshark, and/or any other network monitoring services without departing from embodiments disclosed herein. For additional information regarding the functionality of the network monitors (108), refer to FIG. 2.

In one or more embodiments, the storage (110) may be implemented using one or more volatile or non-volatile storages or any combination thereof. The storage (110) may include the functionality to, or otherwise be configured to, store and provide all, or portions, of information that may be used by the client (100), applications (102), client interface (104), drill-down manager (106), and/or network monitors (108). The information stored in the storage (110) may include retry information (112), tracing information (114), error extraction information (116), and a log repository (118). The storage (110) may include other and/or additional information without departing from embodiments disclosed herein. Each of the aforementioned types of information is discussed below.

In one or more embodiments, the retry information (112) may include one or more data structures that include information associated with the performance of retries of failed network requests. The information may include one or more retry entries. Each entry may be associated with a failed network request. The retry entry may include the network request identifier associated the corresponding network request that failed. The entry may also include a quantity of failures and retries for the corresponding network request and the timestamps associated with the retries and failures. The retry entries may include other and/or additional information associated with the corresponding network request failure retries without departing from embodiments disclosed herein. The retry entries may be generated and updated by the drill-down manager upon the failure and retry of network requests. Entries associated with remediated network request failures may be removed by the drill-down manager.

In addition to the retry entries, the retry information (112) may further include a retry limit. The retry limit may specify a maximum quantity of normal retries to perform on a failed network request, after which drill-down analysis may be performed. The maximum quantity of normal retries may be configured by a user of the system (e.g., a system administrator) and may be any quantity of retries without departing from embodiments disclosed herein. In one or more embodiments, the retry information may further include a drill-down analysis cooldown period during which drill-down analysis may not be performed again for a network request failure until after the cooldown period has expired. As such, the drill-down analysis may not repeatedly be performed in the client, consuming unnecessary resources, bottlenecking client networking resources, and hindering the performance of computer implemented services by the client. The retry information (112) may be used to perform drill-down analysis as discussed in FIG. 2. The retry information (112) may include other and/or additional information associated with network request failure retries without departing from embodiments disclosed herein.

In one or more embodiments, the tracing information (114) may include one or more data structures that include information captured or otherwise obtained by the network monitors during network tracing and performing a network request failure retry as part of the drill-down analysis discussed below in FIG. 2. The tracing information (114) may include packets, frames, stream responses. The tracing information (114) may further include information associated with, or derived from, the packets, frames, and stream responses, including network protocols, SYN packets, ACK packets, secret files, stream identifiers, network interface, client identifier, target identifier, source identifiers, destination identifiers, port numbers, etc. The tracing information (114) may be generated or captured by the network monitors during network tracing. The tracing information (114) may be used to extract the error narrative associated with failed network requests as discussed in FIG. 2. The tracing information (114) may include other and/or additional information without departing from embodiments disclosed herein.

In one or more embodiments, the error extraction information (116) may include one or more data structures that include error narratives associated with each network request failure for which drill-down analysis is performed. In one or more embodiments, the error narratives may be derived from the tracing information by the drill-down manager (106). The error narratives may include error codes, error messages, packet descriptions, packet sequence numbers, frame identifiers, packet lengths, response times, source identifier, target identifier, port numbers, protocols, parameters used in the request (e.g., access keys, codes, usernames, passwords, etc.), etc. The error narratives may include other and/or additional information associated with the cause of network request failures without departing from embodiments disclosed herein. The error narratives may be used by users or remediation services to easily identify the root cause of network request failures and efficiently resolve network request failures. Each error narrative in the error extraction information (116) may be associated with a failed network request (e.g., include the network request identifier). The error extraction information (116) may include other and/or additional information associated with network request failures without departing from embodiments disclosed herein.

In one or more embodiments, the log repository (118) may include one or more data structures that include information regarding network failures. The log repository (118) may include log entries associated with network request failures. Each log entry may be associated with a network request failure. The log entry may include the error narrative and all, or a portion, of the tracing information (both discussed above) captured or extracted during drill-down analysis for the corresponding network operation failure. The log information may be used to provide a comprehensive view of failed network requests and information associated with the failed network requests so that users or entities (e.g., remediation services) attempting to resolve the network request failure may easily be able to identify the root cause of the network request failure and efficiently implement steps to take to resolve the network request failure based on the identified root cause. The log repository (118) may be generated and maintained by the drill-down manager (106). The log repository (118) may include other and/or additional information without departing from embodiments disclosed herein.

While the data structures (e.g., 112, 114, 116, 118) and other data structures mentioned in this Detailed Description are illustrated/discussed as separate data structures and have been discussed as including a limited amount of specific information, any of the aforementioned data structures may be divided into any number of data structures, combined with any number of other data structures, and may include additional, less, and/or different information without departing from embodiments disclosed herein. Additionally, while illustrated as being stored in the storage (110), any of the aforementioned data structures may be stored in different locations (e.g., in storage of other computing devices) and/or spanned across any number of computing devices without departing from embodiments disclosed herein. The data structures discussed in this Detailed Description may be implemented using, for example, file systems, lists, linked lists, tables, unstructured data, databases, etc.

FIG. 2 shows a flowchart of a method for managing network operation failures in accordance with one or more embodiments disclosed herein. The method shown in FIG. 2 may be performed by, for example, a drill-down manager of a client (e.g., 106, FIG. 1B). Other components of the system in FIGS. 1A-1B may perform all, or a portion, of the method of FIG. 2 without departing from the scope of the embodiments described herein. While FIG. 2 is illustrated as a series of steps, any of the steps may be omitted, performed in a different order, additional steps may be included, and/or any or all of the steps may be performed in a parallel and/or partially overlapping manner without departing from the scope of the embodiments described herein.

Initially, in Step 200, a network request failure is identified. In one or more embodiments, the drill-down manager may monitor or obtain information associated with network request (also referred to herein as network operations) between the client and the target. In one or more embodiments, a network request may fail for any reason without departing from embodiments disclosed herein. A network request may fail, for example, if a network timeout limit is reached, if an error code is obtained as a response, if a connection was never established or failed, if the response was different than expected, etc. The drill-down manager may identify any of the aforementioned events or notifications of such events occurring as a network request failure. The network request failure may be identified via other and/or additional methods without departing from embodiments disclosed herein.

In Step 202, a determination is made as to whether a retry limit is exceeded. In one or more embodiments, the drill-down manager may determine whether the retry limit is exceeded using retry information. As discussed above, the retry information may specify a retry limit. The retry limit may specify a maximum number of normal network request failure retries, after which the automatic drill-down method (e.g., Steps 204-220) may be performed. The retry limit may be configured by a user (e.g., a system administrator). Additionally, the retry information may include entries associated with network request retries. The entry may include a network request identifier (e.g., a unique combination of alphanumeric characters that may be used to specify a particular network request) and a quantity of failure and retries associated with the corresponding network request. In one or more embodiments, the drill-down manager may identify the retry entry in the retry information associated with the current network request and compare the quantity of retries with the retry limit. In one or more embodiments disclosed herein, if the quantity of retries associated with the current network request matches the quantity of retries specified by the retry limit, then the drill-down manager may determine that the retry limit is exceeded. In one or more embodiments disclosed herein, if the quantity of retries associated with the current network request is less than the quantity of retries specified by the retry limit, then the drill-down manager may determine that the retry limit is not exceeded. The determination as to whether the retry limit is exceed may be made via other and/or additional methods without departing from embodiments disclosed herein.

In one or more embodiments, if it is determined that the retry limit is exceeded, then the method proceeds to Step 204. In one or more embodiments, if it is determined that an retry limit is not exceeded, then the method proceeds to Step 200 and the drill-down manager may update the retry information entry associated with the current network request to reflect the network request failure.

In Step 204, other retry methods and network requests are paused. In one or more embodiments, the drill-down manager may pause other retry methods for the network request. As such, the drill-down manager or other entity performing network retries may not perform other network retry methods for the short time (e.g., in the ones or tens of milliseconds) that the drill-down analysis is performed for the network request to prevent an overload of the network and IO resources of the client and the target. Additionally, the drill-down manager may pause network requests between the client and the target. In one embodiment, the drill-down manager may pause all network requests regardless of request types. In other embodiments, the drill-down manager may pause only requests associated with one or more request types. The request types may include, for example, GET, POST, PUT, PATCH, DELETE request types for HTTP networks, or the equivalent in other network protocols. The requests types may include other and/or additional types of requests without departing from embodiments disclosed herein. In such embodiments, the drill-down manager may reduce the network and IO demand on the client and target while not completely pausing all network requests. Accordingly, the client or other entity (e.g., applications) performing network requests may not perform any or a portion of network requests for the short time (e.g., in the ones or tens of milliseconds) that the drill-down analysis is performed for the network request to prevent an overload of the network and IO resources of the client and the target. Other retry methods and network requests may be paused via other and/or additional methods without departing from embodiments disclosed herein.

In Step 206, network tracing is triggered for the network requests. In one or more embodiments, the drill-down manager may initiate execution of the appropriate network tracing services. As discussed above, network monitoring services or other network telemetry collectors executing on, or operatively connected to, the client and/or the target and may generate tracing information associated with the performance of the retry of the network request. In one or more embodiments, the drill-down manager may send a request to the network monitors to perform network tracing associated with the network request retry. The request may specify the network request (e.g., the network request identifier), the duration of tracing services, etc. In response to obtaining the request, one or more network monitors executing on, or operatively connected to, the client and/or the target may begin performing the network tracing. The network tracing may be triggered for the network request via other and/or additional methods without departing from embodiments disclosed herein.

In Step 208, a retry of the network request is performed with network tracing. In one or more embodiments, the drill-down manager may initiate the retry performance of the failed network request. Accordingly, applications or other entities of the client may retry the network request to the target. At the same time, the network monitors may perform network tracing and capture all of the data packets, error messages, notifications, etc. sent during the execution of the network request and obtained in response to the network request. The data packets, error messages, and/or notifications generated during the network tracing may include the tracing information generated by the network monitors. Additionally, if required, a premaster secret file may also be generated and used for the retry operation to satisfy security requirements of the network protocol (e.g., HTTPS). The retry of the network request may be performed with network tracing via other and/or additional methods without departing from embodiments disclosed herein.

In Step 210, other network requests and retry methods are resumed. In one or more embodiments, the drill-down manager may send a request to applications or other entities to perform other retry methods for the network request and begin performing other network requests. As such, after the tens of milliseconds required to retry the failed network request with the network monitors performing network tracing, the client may begin performing other retry methods and all other network requests to resume providing and/or obtaining from the target computer implemented services for the user of the client. Other retry methods and network requests may be resumed via other and/or additional methods without departing from embodiments disclosed herein.

In Step 212, the tracing information is filtered to obtain packets associated with the failed network request. As discussed above, the network monitors may perform network tracing to obtain tracing information. The tracing information may include packets associated with network operations performed by the client and target including the retry of the failed network request and other network requests that are not relevant to the drill-down analysis. In one or more embodiments, the drill-down manager may filter the tracing information using one or more filtering parameters included in the tracing information that are associated with the failed network request. The filtering parameters may include a network interface identifier, a destination hostname, a port number, a protocol type, etc. The filtering parameters may include other and/or additional filtering parameters without departing from embodiments disclosed herein. Accordingly, the drill-down manager may only obtain the tracing information associated with the one or more filtering parameters. The tracing information may be filtered to obtain packets associated with the failed network request via other and/or additional methods without departing from embodiments disclosed herein.

In Step 214, a stream identifier associated with the network request retry is identified. In one or more embodiments, the drill-down manager may obtain the stream identifier associated with the network request retry from the tracing information. As an example, the drill-down manager may obtain the synchronize (SYN) packet associated with the network request retry from the tracing information. The SYN packet may include a stream identifier (e.g., a TCP stream identifier) that may be used to track the exchange of communications between the client and the target associated with the network request retry. Each packet associated with the network request retry may include the stream identifier. The stream identifier associated with the network request retry may be used to further obtain tracing information associated with the network request retry. The stream identifier associated with the network request retry may be identified via other and/or additional methods without departing from embodiments disclosed herein.

In Step 216, extraction of the packets and retry stream responses associated with the stream identifier is performed to obtain an error narrative. In one or more embodiments, the drill-down manager may parse and analyze the packets and retry stream responses included in the tracing information associated with the network request retry to obtain an error narrative. In one or more embodiments, the error narrative may refer to one or more data structures that includes information that may specify a cause of the network request failure. The information may include error codes, error messages, packet descriptions, packet sequence numbers, frame identifiers, packet lengths, response times, source identifier, target identifier, port numbers, protocols, parameters used in the request (e.g., access keys, codes, usernames, passwords, etc.), etc. The information included in the error narrative may include other and/or additional types of information associated with network request failures without departing from embodiments disclosed herein. The information included in the error narrative may be extracted from one or more packets associated with the network retry request and response stream associated with the network retry request. Extraction of the packets and retry stream responses associated with the stream identifier may be performed to obtain an error narrative via other and/or additional methods without departing from embodiments disclosed herein.

In Step 218, the error narrative is stored in the log repository. In one or more embodiments, the drill-down manager may generate a new entry in the log repository. The drill-down manager may include the error narrative, the network retry request identifier, and the retry information associated with the network retry request, in the entry of the log repository. As such the error narrative may be used to identify the root cause of the network request failure and to efficiently remediate the network request failure. The error narrative may be stored in the log repository via other and/or additional methods without departing from embodiments disclosed herein.

In Step 220, the network request failure remediation is initiated using the error narrative. In one or more embodiments, the drill-down manager may send a request to user (e.g., a system administrator, an IT manager, etc.) network request failure remediation service (e.g., executing on the client (e.g., not shown in FIGS. 1A-1B) or an external entity) to remediate the network request failure. The request may include the error narrative and information included in the log repository entry associated with the network request failure. Accordingly, in response to obtaining the request the user or the network request remediation service may more efficiently identify the root cause of the network request failure. Thus, the time required to remediate the network request failure may be greatly reduced thereby improving the operation of the client and target when performing computer implemented services. The network request failure remediation may be initiated using the error narrative via other and/or additional method without departing from embodiments disclosed herein.

In one or more embodiments, the method ends following Step 220.

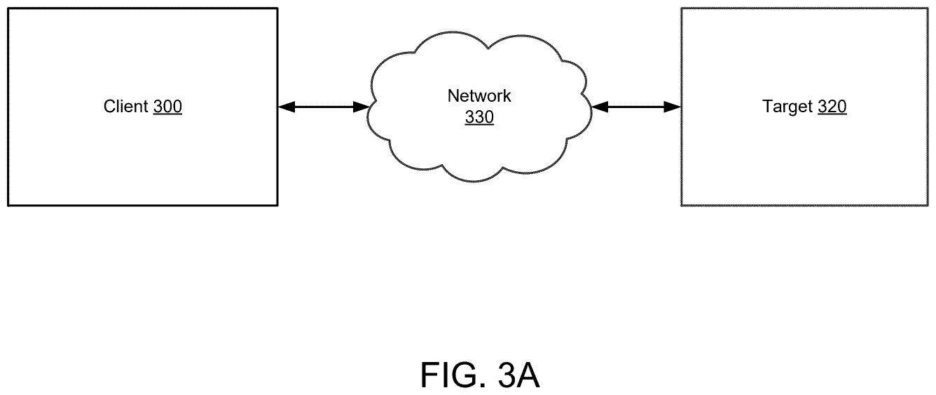

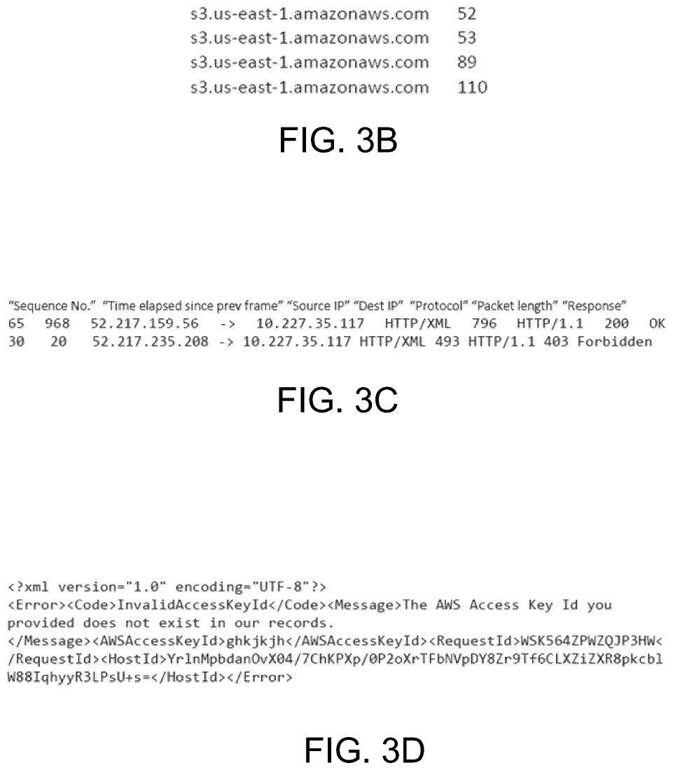

To further clarify embodiments of the invention, a non-limiting example use case is provided in FIGS. 3A-3D.

### Start of Example

The example use case, illustrated in FIGS. 3A-3D, is not intended to limit the scope of the embodiments disclosed herein and is independent from any other examples discussed in this application. FIG. 3A shows an example system and FIGS. 3B-3D illustrate example data structures generated or used by the system during the performance of the example.

Turning now to FIG. 3A, FIG. 3A shows a diagram of the example system. For the sake of brevity, not all components involved in the system of FIGS. 1A-1B are included in the example system FIG. 3A.

The example system includes a client (300) and a target (320) operatively connected to each other via a network (330). The client (300) performs computer implemented services for a user (not shown). To do so, the client (300) obtains a portion of the computer implemented services from the target (320). Accordingly, the client (300) sends network requests to the target (320).

Continuing with the discussion of the example, at a first point in time, the client (300) attempts to send a network request (S3 request) to the target (320) but an error code was returned. The drill down manager of the client (300) identifies the network request failure. The drill down manager of the client (300) then checks the retry information and finds that the network request has not been retried so there is no retry information associated with the network request. The drill-down manager also identifies that the retry limit is one (e.g., the original performance of the network request and one subsequent retry). Based on the above, the drill-down manager determines that the retry limit has not been reached. In response to the determination, the drill down manager creates an entry in the retry information associated with the network request and initiates a retry of the network request.

Sometime later, the network request is retried and fails again. The drill down manager of the client (300) identifies the network request failure. The drill down manager of the client (300) then checks the retry information and finds that the network request has been retried. The drill-down manager also identifies that the retry limit is one (e.g., the original performance of the network request and one subsequent retry). Based on the above, the drill-down manager determines that the retry limit has been reached. In response to the determination, the drill down manager then begins drill-down analysis for the network request.

The drill down manager then pauses other retry methods and network requests from the client to the target to avoid disrupting the drill-down analysis and resulting in failures of other network requests due to the drill-down analysis. The drill-down manager then triggers network tracing for a retry of the network request in the capture phase of the drill-down analysis. Accordingly, network monitors may begin executing and generating tracing information based on the performance of network request between the client (300) and the target (320). Next, the drill-down manager retries the network request with the network monitors performing network tracing to generate tracing information. After the network request is retried and fails again, the drill-down manager resumes other network requests and retry methods and enters the analysis phase of the drill-down analysis.

The drill-down manager then filters the tracing information to only include relevant packets, frames, and stream responses associated with the network request. Additionally, the drill down manager may identify a stream identifier associated with the network request using a corresponding SYN packet. The drill-down manager may also filter out stream responses to only include stream responses with the stream identifier associated with the network request. Turning to FIG. 3B, FIG. 3B shows an example list of streams between the client (300) and the target (320). The list may include the target hostname “s3.us-east-1.amazonaws.com” and stream identifiers including “52”, “53” “89”, and “110”. The stream identifier is 53. As such, only frames related to stream identifier 53 may be selected for analysis and the other frames may be filtered out. FIG. 3C shows a diagram of example frames included in the tracing information associated with the network request that are responses from the target (320). As shown in FIG. 3C the frames include codes 200 and 403 which specify that the request was processed and there was a permission issue respectively. The drill-down manager then analyzes the packets, frames, and stream responses and extract an error narrative associated with the network request failure. The error narrative includes the error codes shown in FIG. 3C.

The drill-down manager also analyzes packet lengths to determine if content was dropped or lost during transmission, analyzes response times to identify any server delays or bottlenecks, and checks for ACK packets to confirm that target (320) is reachable. The drill-down manager also analyzes and extracts messages included in the packets. FIG. 3D shows an example message. As shown in FIG. 3D, the message indicates that the incorrect access key was used in the network request and specifies the incorrect access key used. The drill-down manager may include all of the aforementioned extracted information in the error narrative.

After generating the error narrative, the drill-down manager generates a new entry in the log repository and includes the error narrative and associated tracing information and retry information in the log repository entry. The drill-down manager may then initiate network request failure remediation using the log repository entry associated with the network request error. Entities performing remediation may include a comprehensive view of the network request failure instead of only having the network request response error code. By scanning the error narrative, the entities may quickly determine that the wrong access key was provided in the failed network request and which incorrect access key was used. Accordingly, the entities may simply fetch the proper access key and retry the failed network request with the proper access key.

### End of Example

As discussed above, embodiments of the invention may be implemented using computing devices. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

As used herein, an entity that is programmed to, or configured to, perform a function (e.g., step, action, etc.) refers to one or more hardware devices (e.g., processors, digital signal processors, field programmable gate arrays, application specific integrated circuits, etc.) that provide the function. The hardware devices may be programmed to do so by, for example, being able to execute computer instructions (e.g., computer code) that cause the hardware devices to provide the function. In another example, the hardware device may be programmed to do so by having circuitry that has been adapted (e.g., modified) to perform the function. An entity that is programmed to perform a function does not include computer instructions in isolation from any hardware devices. Computer instructions may be used to program a hardware device that, when programmed, provides the function.

The problems discussed above should be understood as being examples of problems solved by embodiments of the invention of the invention and the invention should not be limited to solving the same/similar problems. The disclosed invention is broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention as of the invention. Accordingly, the scope of the invention should be limited only by the attached claims.

What is claimed is:

1. A method for managing network request failures, comprising:
identifying, by a drill-down manager of a client, a network request failure, wherein the network request is sent by the client to a target through a network;
in response to the identification:
making a determination that a retry limit is exceeded;
in response to the determination:
pausing other retry methods and network requests;
after pausing:
triggering network tracing for network requests;
performing a retry of the failed network request with the network tracing;
after performing the retry:
resuming other network requests and retry methods;
filtering tracing information obtained from the network tracing to obtain packets associated with the failed network request;
identifying a retry stream identifier associated with retry stream responses of the network request retry;
performing extraction of the packets and the retry stream responses associated with the stream identifier to obtain an error narrative;
storing the error narrative in a log repository; and
initiating network request failure remediation using the error narrative.

2. The method of claim 1, wherein the error narrative comprises information extracted from the packets and retry stream responses and used in remediating the network request failure.

3. The method of claim 1, wherein pausing other network requests comprises pausing all network requests from the client.

4. The method of claim 1, wherein pausing other network requests comprises pausing network requests from the client of a request type of request types.

5. The method of claim 4, wherein pausing other network requests further comprises:
pausing requests of a first request type of the request types; and
not pausing requests of a second request type of the requests types.

6. The method of claim 1, wherein performing extraction of the packets and the retry stream responses associated with the stream identifier to obtain an error narrative further comprises identifying error messages in the packets and the retry stream responses and analyzing the error messages to obtain failure attributes.

7. The method of claim 1, wherein initiating the network request failure remediation using the error narrative comprises identifying a root cause of the network request failure based on the error narrative.

8. A non-transitory computer readable medium comprising computer readable program code, which when executed by a computer processor enables the computer processor to perform a method for managing network request failures, the method comprising:
identifying, by a drill-down manager of a client, a network request failure, wherein the network request is sent by the client to a target through a network;
in response to the identification:
making a determination that a retry limit is exceeded;
in response to the determination:
pausing other retry methods and network requests;
after pausing:
triggering network tracing for network requests;
performing a retry of the failed network request with the network tracing;
after performing the retry:
resuming other network requests and retry methods;
filtering tracing information obtained from the network tracing to obtain packets associated with the failed network request;
identifying a retry stream identifier associated with retry stream responses of the network request retry;
performing extraction of the packets and the retry stream responses associated with the stream identifier to obtain an error narrative;
storing the error narrative in a log repository; and
initiating network request failure remediation using the error narrative.

9. The non-transitory computer readable medium of claim 8, wherein the error narrative comprises information extracted from the packets and retry stream responses and used in remediating the network request failure.

10. The non-transitory computer readable medium of claim 8, wherein pausing other network requests comprises pausing all network requests from the client.

11. The non-transitory computer readable medium of claim 8, wherein pausing other network requests comprises pausing network requests from the client of a request type of requests types.

12. The non-transitory computer readable medium of claim 11, wherein pausing other network requests further comprises:
pausing requests of a first request type of the request types; and
not pausing requests of a second request type of the requests types.

13. The non-transitory computer readable medium of claim 8, wherein performing extraction of the packets and the retry stream responses associated with the stream identifier to obtain an error narrative further comprises identifying error messages in the packets and the retry stream responses and analyzing the error messages to obtain failure attributes.

14. The non-transitory computer readable medium of claim 8, wherein initiating the network request failure remediation using the error narrative comprises identifying a root cause of the network request failure based on the error narrative.

15. A system for managing network request failures, comprising:
a target; and
a client operatively connected to the target, wherein the client comprises a processor and memory and the processor is configured to perform a method comprising:
identifying a network request failure, wherein the network request is sent by the client to the target through a network;
in response to the identification:
making a determination that a retry limit is exceeded;
in response to the determination:
pausing other retry methods and network requests;
after pausing:
triggering network tracing for network requests;
performing a retry of the failed network request with the network tracing;
after performing the retry:
resuming other network requests and retry methods;
filtering tracing information obtained from the network tracing to obtain packets associated with the failed network request;
identifying a retry stream identifier associated with retry stream responses of the network request retry;
performing extraction of the packets and the retry stream responses associated with the stream identifier to obtain an error narrative;
storing the error narrative in a log repository; and
initiating network request failure remediation using the error narrative.

16. The system of claim 15, wherein the error narrative comprises information extracted from the packets and retry stream responses and used in remediating the network request failure.

17. The system of claim 15, wherein pausing other network requests comprises pausing all network requests from the client.

18. The system of claim 15, wherein pausing other network requests comprises pausing network requests from the client of a request type of request types.

19. The system of claim 18, wherein pausing other network requests further comprises:
pausing requests of a first request type of the request types; and
not pausing requests of a second request type of the requests types.

20. The system of claim 15, wherein performing extraction of the packets and the retry stream responses associated with the stream identifier to obtain an error narrative further comprises identifying error messages in the packets and the retry stream responses and analyzing the error messages to obtain failure attributes.
